(19) United States
(12) Patent Application Publication
(10) Pub. No.: US 2008/0065580 A1
(43) Pub. Date: Mar. 13, 2008

(54) Unified user work environment for surfacing cross document relationships and componentized functionality

(75) Inventors: Jeanine E. Spence, Seattle, WA (US); Wai Chan, Bellevue, WA (US); Scott Neilson, Seattle, WA (US); Kathleen Linscott, Seattle, WA (US); David M. Bozich, Enumclaw, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/518,671

(22) Filed: Sep. 11, 2006

(51) Int. Cl. G06F 15/18

(52) U.S. Cl. 706/62

(57) ABSTRACT

A unified workspace (UWS) design that provides a single system-wide display and interaction surface, and a set of tools that allow a user to discover relevant information. Data is surfaced across boundaries of applications and documents and stored implicitly from preset business logic or explicitly from user demand. Data can be implicitly and explicitly queried and aggregated from many different data sources such as various content types that are created in different formats and displayed on a single interaction surface. The UWS surfaces the required application functionalities to perform the tasks by partial launch of the associated application. Data elevation surfaces only the relevant amount of information, based on the context and activity, to assist the completion and decisionmaking process. Private and shared workspaces can be employed with object passing therebetween. The UWS provides a visual representation of each element such as information or relationship and allows direct user interaction.

### BACKGROUND

Conventional work surfaces lack many features and capabilities that are desirable for a productive application work environment. For example, conventional work surfaces do not provide direct support to the end user in the need for the user to view large amounts of information at a glance and assistance in correlating data across different types of documents or types of media; the need to recreate the context of a past decision, and a consistent means for retrieving information dispersed across many applications, formats, and locations; and, the need to reliably share grouped or related information with other users (internally and externally in a co-located and/or a distributed environment).

Applications typically require the operation of the whole and independent application environment to make any kind of modification to the informational data even for the minor changes and the changes made in one environment do not affect the related information in other application environments. Switching between applications to update the same information multiple times or simply in the course of producing documents in order to complete a task creates a jarring and less productive user experience. Moreover, the information the user works with is no longer solely individual text-based documents (available for text based search correlation), but now is also distributed in database business applications, in conversation logs and in a wide range of media including images, audio, video, graphics, fax and telephony, for example.

In the fast-paced and now, data rich environments, the user is currently challenged to locate and identify important information quickly and efficiently. Moreover, unnecessary information is presented to the user when all they are looking for is just one piece of data from a whole document. To make the problem worse, the user may need to perform extra tasks and additional steps of translation to access the specific data. In other words, there is a lot of referencing and mining required to find the desired information.

In support of viewing and interacting with larger amounts and types of data, the rapid evolution of display technology now provides large high-resolution displays that allow the user to present multiple documents of different applications. Additionally, multiple displays can be utilized on a single computer to provide an even larger work surface for user interaction and data presentation. Accordingly, once located and made accessible, it can be difficult to remember the placement of items when working on large or high-density display surfaces without visual landmarks. Due to the fact that conventionally, documents are associated only with the application and one application is not connected to another application, all the documents that the user works with to complete a task are not associated with each other by any other means than the user's ability to remember the relationships and associations. Thus, when one document is positioned on a large screen, other documents do not rearrange accordingly.

Moreover, the conventional cascading menu interface presents major problems in navigating multi-leveled menus, and functions on the menus are not necessarily applied to the task on hand. The conventional cascading menus are organized by application and do not help the user to locate actions that are specifically relevant to the work in which they are engaged. In other words, the menus are broadly applied to the application, and not specific to the task on hand. Due to the technological advances of system hardware and the greater technical sophistication of the typical computer user, conventional work environments are lagging behind in effectiveness and capabilities.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The disclosed innovation facilitates the visual presentation of sets of information and the relationships between the information sets. A user can interact directly with the information sets and relationships, and the interaction results are stored for later access and processing.

Additionally, a unified workspace (UWS) design is provided that addresses the shortcomings of conventional systems and methods by providing a single system-wide display and interaction surface, and a set of tools that allow the user to discover and work with relevant information regardless of the traditional application it may have been created in. The user interface (UI) surfaces the necessary data across the boundaries of applications, stores implicitly from preset business logic or explicitly from user demand, and can show other relevant data points at the interface periphery. The information is oriented to position the most relevant information (extracted from its application context) in the center of the UWS and position less tightly related information at the periphery as well as links to other sources of information not displayed in detail.

The architecture provides the capability to query and aggregate data from many different data sources such as various content types that are created in different formats (e.g., text, audio, video, images, etc.) and display the search results on a single interaction surface. In one example, if data exception appears, the system flags the information in question and presents the information on the same surface to ease the user's burden in the process of investigation, evaluation and decisionmaking.

The architecture also provides the capability to incorporate business process logic to implicitly elevate important and relevant information to the display surface to support a user's decisionmaking process.

The architecture provides the capability to elevate functions across applications. Based on the type of information and context, the UI then surfaces the required application functionalities to perform the tasks on the information without launching the full application itself. Further, based on attributes of the business, device, access privilege, and task, these application functions can be implicitly scaled. In other words, the architecture can populate a set of customized functions to meet the needs of different problem in a different situation.

The architecture also provides data elevation, which is the capability to surface only the relevant amount of information, based on the context and activity, to assist the completion and decisionmaking process. Alternatively or in combination therewith, a user can explicitly request to surface additional information to the limit of the entire document.

In support thereof, the architecture disclosed and claimed herein comprises a computer-implemented system that facilitates a user work environment. The system includes a presentation component for providing a visual presentation of sets of information and a relationship between the sets of information; and an application component that allows direct user interaction with the sets of information and the relationship, and preserves results of the user interaction. A workspace component can be provided for providing a single interaction surface via which to perform a task related to at least one of display of data and user interaction. An application component can be included for automatically providing an application function from a plurality of different applications for use in performing the task based on type of the data and context, the application function provided without launching an associated application that provides the function.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a computer-implemented system that facilitates a user work environment.

FIG. 2 illustrates an alternative system that facilitates a user work environment.

FIG. 3 illustrates a computer-implemented methodology of providing a user work environment using information sets and set relationships in accordance with the subject innovation.

FIG. 4 illustrates a computer-implemented methodology of providing a single unified user work environment.

FIG. 5 illustrates a methodology of elevating data in accordance with the data component.

FIG. 6 illustrates a methodology of utilizing graphics at visual aids to enhance user experience.

FIG. 7 illustrates a methodology of providing query features for the unified workspace.

FIG. 8 illustrates a methodology of presenting and utilizing object relationships for visual effectiveness.

FIG. 9 illustrates a methodology of providing a shared workspace as part of the unified workspace.

FIG. 10 illustrates a methodology of changing workspace boundaries as part of the user interaction.

FIG. 11 illustrates a methodology of processing collaboration communications in accordance with a shared workspace.

FIG. 12 illustrates a methodology of presenting mixed media types and sharing of data objects.

FIG. 13 illustrates a methodology of providing workspace communications according to a best communications method.

FIG. 14 illustrates a methodology of processing search results by linking results to related data.

FIG. 15 illustrates a methodology of providing a visually intuitive user experience for a user work environment.

FIG. 16 illustrates a methodology of creating and modifying data object relationships of a workspace.

FIG. 17 illustrates the basic unified workspace having a single work surface for user and data interaction.

FIG. 18 illustrates a screenshot that represents capabilities of the unified workspace.

FIG. 19 illustrates a screenshot that represents the capability of data elevation and layering in accordance with the disclosed architecture.

FIG. 20 illustrates a data elevation Level 1 surfacing of data related to a purchase order of FIG. 19.

FIG. 21 illustrates a data elevation Level 2 exposure of more data in a document marked as secondarily relevant.

FIG. 22 illustrates a data elevation Level 3 surfacing of the entire data document.

FIG. 23 illustrates data elevation of related objects.

FIG. 24 illustrates that content is elevated based on relationships.

FIG. 25 illustrates a ring menu that is presented near the point of user activity.

FIG. 26 illustrates a query list on the workspace.

FIG. 27 illustrates meaningful regions in business logic implementation of the workspace work surface.

FIG. 28 illustrates that by adjusting object proximity, creation and/or changing of a query will be affected.

FIG. 29 illustrates the use of line style and weight to indicate the strength and relationship type.

FIG. 30 illustrates the use of color and opacity in object appearance to represent data/data object relevancy.

FIG. 31 illustrates the creation of a shared workspace in a private workspace.

FIG. 32 illustrates that objects can be dragged between private and public workspaces to share the objects.

FIG. 33 illustrates that moving objects from the shared workspace into the private workspace triggers business rules for the system to launch web services that retrieve more relevant data.

FIG. 34 illustrates that a shared workspace user can participate remotely by voice that can be converted into text and displayed as an ongoing dialogue on the work surface.

FIG. 35 illustrates an initial layout of workspace coverage before user expansion of user spaces.

FIG. 36 illustrates the final layout or expansion of the user spaces.

FIG. 37 illustrates the various modes of communications that can be facilitated by the unified workspace environment.

FIG. 38 illustrates the layering of disparate media types via the workspace.

FIG. 39 illustrates a block diagram of a computer operable to execute the disclosed unified workspace architecture.

FIG. 40 illustrates a schematic block diagram of an exemplary computing environment that facilitates communications and data exchange for users of the unified workspace environment.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The disclosed innovation is a:user interface (UI) that includes a unified workspace (UWS) design for presenting a single display and interaction surface for the visual presentation of sets of information and the relationships between the information sets. A user can interact directly with the information sets and relationships, and the interaction results are stored for later access and processing.

The UI includes a set of tools that allow the user to discover and interact with relevant information. The UWS includes an aggregated display function using a single work surface to show all data from all sources. The sources can present different content type and format (e.g., text, audio, video, images, . . . ). The UWS can be considered a private workspace for a single user, and also facilitates creation of a shared (or public) workspace for two or more users for the communication and/or exchange of information and data objects. Objects put inside the shared workspace are accessible by all shared workspace users. Moreover, objects can be easily dragged between the private and shared workspaces, both sharing a common work surface from which to view data and other graphical representations. As objects move between the workspaces, the system preserves the object relationships and object/usage context.

The UI presents other relevant data points at the interface periphery. The UWS of the UI can present search results for data/documents using a relationship map (or tree). The map links the search results visually to their related data. Additionally, the map links serve as a visual cue to allow the user(s) to follow the relationship tree to discover other relevant data. Other feature graphics are employed on the work surface to provide visual cues as to the status and relationship of data. For example, line styles, line weight, object/text opacity and, object color and size are employed to show relevancy, importance, and relationships.

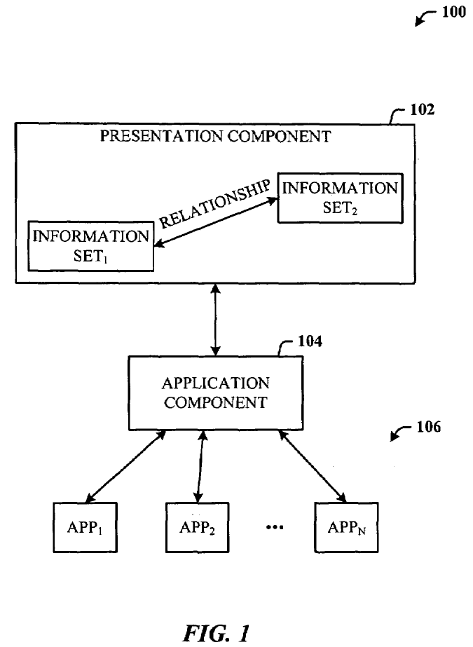

Referring initially to the drawings, FIG. 1 illustrates a computer-implemented system 100 that facilitates a user work environment. The system 100 includes a presentation component 102 for providing a visual and graphical presentation of information (e.g., sets of information or data objects) and relationships between the information (or data objects). The system 100 can also include an application component 104 that allows direct user interaction with the sets of information and the relationship, and preserves results of the user interaction. The application component 104 also automatically provides an application function from a plurality of different applications 106 (denoted APP₁, APP₂, . . . ,APP_{N}, where N is a positive integer) for use in performing the task based on type of the data and context, the application function provided without launching an associated application that provides the function.

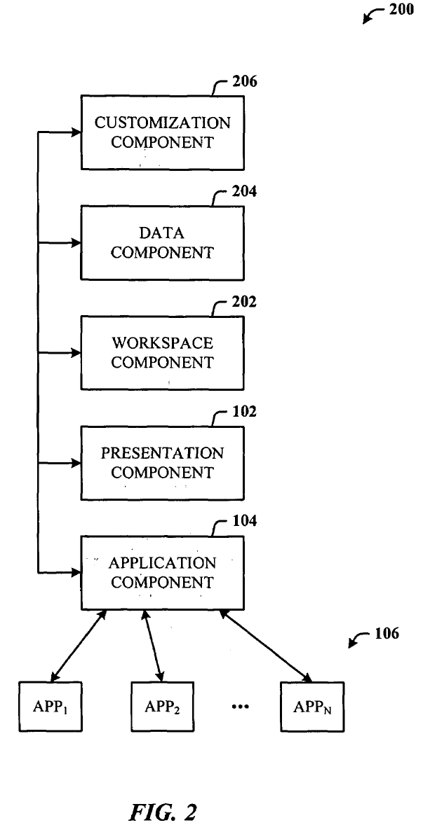

FIG. 2 illustrates an alternative system 200 that facilitates a user work environment. The system 200 includes the presentation component 102 for visual presentation of sets of information and the application component 104 for user interaction with the information sets and/or relationships via the automatic provisioning of application functions from the plurality of different applications 106 for use in performing the task, the application functions provided by partially launching the associated application that provides the function.

Additionally, the system 200 can include a workspace component 202 for providing a single interaction surface via which to perform a task related to at least one of display of data and user interaction. A data component 204 facilitates elevating only the right amount of data (the relevant data) associated with a task to the workspace component 202 for access at the work surface. The data component 204 facilitates aggregation of different types of the data and surfacing of only the relevant different types of the data for presentation via the surface. The data component 204 facilitates implicit surfacing of the relevant data, as well as explicit surfacing by user demand. The relevant data surfaced by the data component can be at least predefined by a user, defined at design time, and system learned. Additionally, the relevant data surfaced by the data component forms a basis for accessing a remaining portion of the data.

The workspace component 202 facilitates the UWS, normally considered a private workspace (PWS) for a single user, and which facilitates creation of a shared (or public) workspace (SWS) for two or more users for the communication and/or exchange of information and data objects. Objects put inside the SWS are accessible by all SWS users. Moreover, objects can be easily dragged between the PWS and the SWS, both sharing a common work surface from which to view data and other graphical representations. As objects move between the workspaces, the system preserves the object relationships and object/usage context.

The UI surfaces the necessary data across the boundaries of the applications 106, stores data and settings implicitly (e.g., from preset business logic) and/or explicitly from user demand. The UI also can show other relevant data points at the interface periphery. The UWS of the UI can present search results for data/documents using a relationship map (or tree). The map links the search results visually to their related data. Additionally, the map links serve as a visual cue to allow the user(s) to follow the relationship tree to discover other relevant data. The display surface can switch to become an editing surface to allow direct manipulation of the data/information.

The system 200 can also include a customization component 206 for providing a customized set of application functions related to a specific aspect of a user task associated with the sets of information.

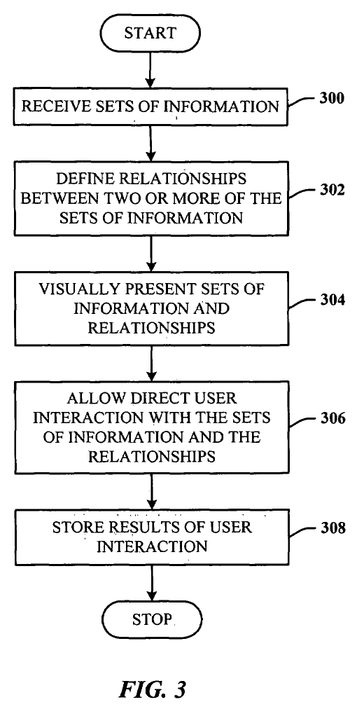

FIGS. 3-16 illustrate methodologies associated with various aspects of the disclosed architecture. While, for purposes of simplicity of explanation, the one or more methodologies shown herein, for example, in the form of a flow chart or flow diagram, are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

FIG. 3 illustrates a computer-implemented methodology of providing a user work environment using information sets and set relationships in accordance with the subject innovation. At 300, one or more sets of information (or data objects) are received or elevated to the work surface for visual and graphical presentation. At 302, relationships can be defined between the information sets. At 304, the information sets and associated relationships are presented via the UI. At 306, direct user interaction with the information sets (or data objects) and relationships is allowed. At 308, the user interaction results are stored for later access or processing.

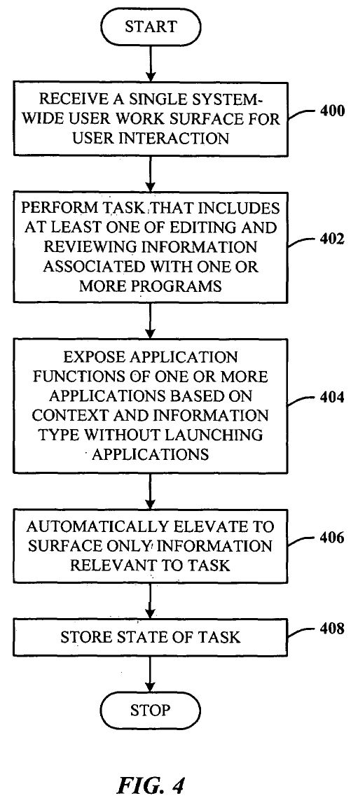

FIG. 4 illustrates a computer-implemented methodology of providing a single unified user work environment. At 400, a single system-wide user work surface is provided for user interaction. At 402, a task is performed that includes at least one of editing and reviewing information associated with one or more applications. At 404, application functions of the one or more applications are exposed based on at least one of context and type of the information, the functions exposed without launching the associated application. At 406, only data, data objects, and/or documents relevant to the task are elevated to the work surface. At 408, the system stores the current state of the data, data objects, and/or documents, as well as other settings and interaction information.

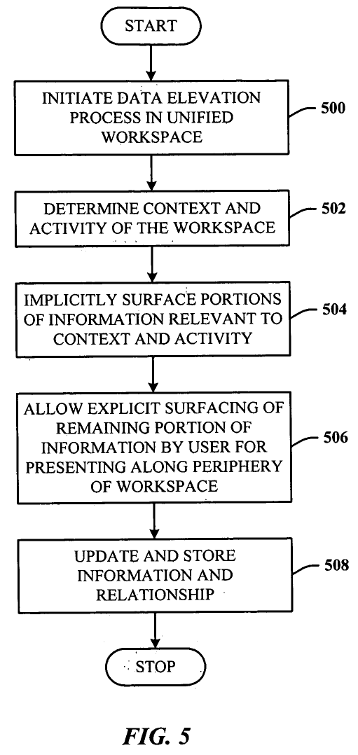

FIG. 5 illustrates a methodology of elevating data in accordance with the data component. At 500, a data elevation process is initiated. At 502, context (e.g., user context, data context) and activity (e.g., user activity, system activity) of the workspace is determined. At 504, portions of the data (or of a total document) relevant to the context and/or activity are implicitly surfaced. At 506, optionally, remaining portions of the data (or document) can be explicitly surfaced by the user and presented along the work surface periphery. At 508, settings and data changes and relationships can be stored for later access and work surface access.

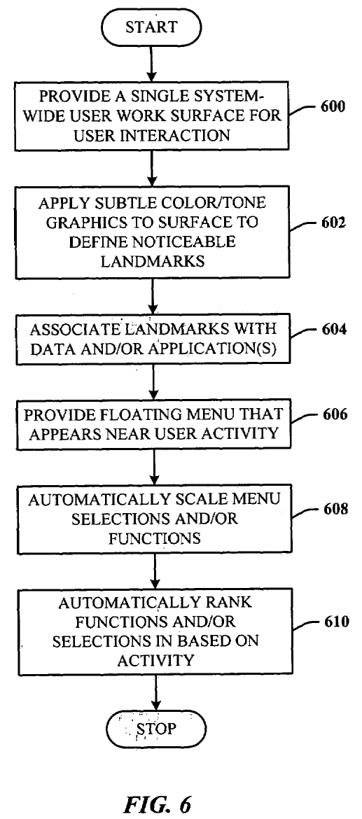

FIG. 6 illustrates a methodology of utilizing graphics at visual aids to enhance user experience. At 600, a single system-wide user work surface is provided for user interaction. In other words, no viewport (e.g., separate windows) other than the work surface needs to be opened or utilized when performing tasks or interacting with the system. All system functionality from applications and data manipulation can be obtained from the work surface, whether in a private and/or shared workspace mode. At 602, subtle graphical colors and tones are applied to the work surface and icons (or other indicia) to define noticeable landmarks (or meaningful regions). At 604, data and/or applications (e.g., business logic) can be associated with landmarks. For example, purchase orders can be associated with a first landmark, customers can be associated with another landmark, etc. At 606, in support of user interaction, a floating menu is provided that is materialized near the user activity, for example, at or near a mouse pointer. In one implementation, the menu uses a ring menu where selections are associated with ring segments. At 608, the menu can be automatically scaled to present relevant selections and/or application functions. At 610, based on user activity, for example, the functions and/or selections can be ranked. The ring menu provides the capability to access menu items from anywhere on the display surface, and access content/activity-specific menus (content-sensitive) from an individual object.

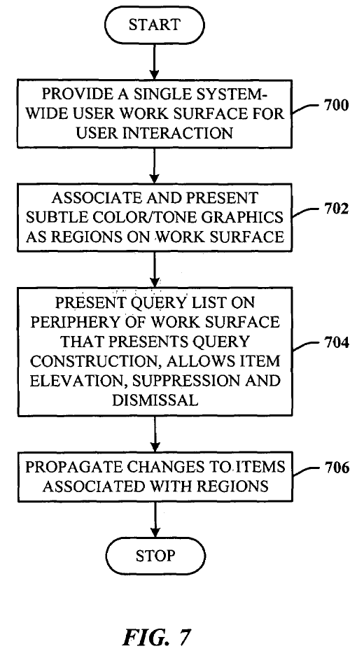

Referring now to FIG. 7, there is illustrated a methodology of providing query features for the unified workspace. A query list is the concept of using text-based query criteria strings at or near the bottom of the UWS, for example, to create and display the query construction, and to allow the user to elevate, suppress, and dismiss items. The changes to the text string can affect one or multiple regions on the workspace. At 700, a single system-wide user work surface is provided for user interaction. At 702, subtle colors and tones are associated and presented with defined regions of the work surface. At 704, a query list is presented on a periphery of the work surface. The list presents query construction, allows item elevation, suppression, and dismissal. At 706, changes are propagated to items associated with the regions.

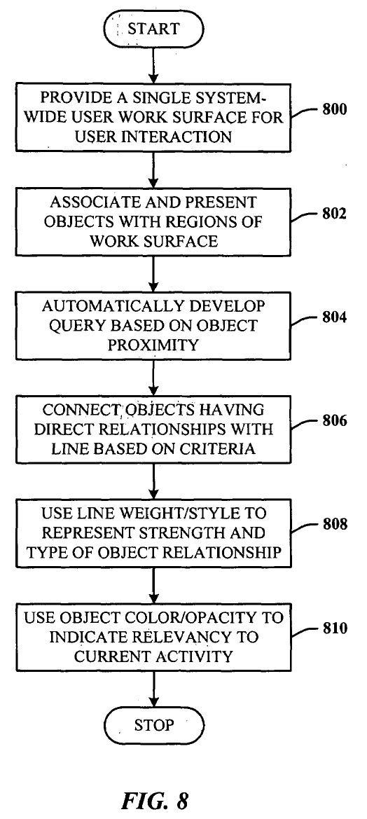

FIG. 8 illustrates a methodology of presenting and utilizing object relationships for visual effectiveness. At 800, a single system-wide user work surface is provided for user interaction. At 802, data objects are presented and associated with predefined regions of the work surface. At 804, a query if automatically generated based on object proximity. For example, if the user drags one data object into close proximity of another data object, the system interprets (or infers) this user interaction as a prelude to developing a query related to one or more of the two objects. The query operation supports the data elevation aspect of the disclosed innovation such that only relevant data is surfaced for the context and/or user activity. At 806, objects having direct relationships, as determined by criteria, can be represented by a line therebetween. At 808, the strength and type of the object relationship can further be represented by line weight (e.g., 3-point, 5-point, etc.), and line style (e.g., solid, dashed, dotted, etc.). At 810, object color and/or opacity can be used to represent relevancy to the current activity and/or context.

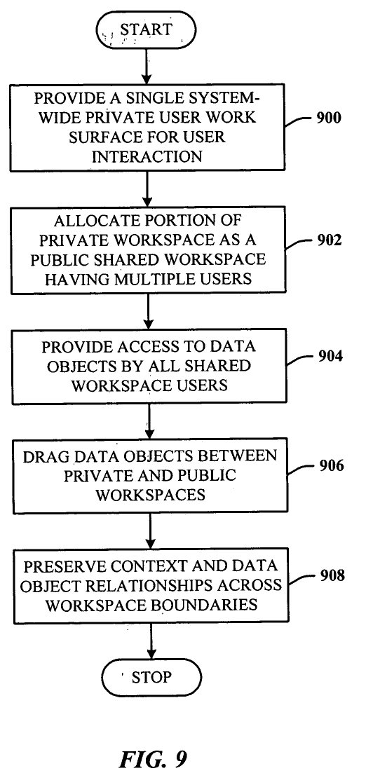

FIG. 9 illustrates a methodology of providing a shared workspace as part of the unified workspace. At 900, a single system-wide user private work surface is provided for user interaction by a local user. At 902, a portion of the private workspace is allocated (or configured) as a shared workspace for interaction by multiple remote users (one of which can be the local user). At 904, the shared workspace provides access to data objects in the shared workspace. At 906, data objects can be dragged between the shared and private workspaces. Additionally, access rights automatically apply accordingly. At 908, context and data object relationships are preserved across workspace boundaries.

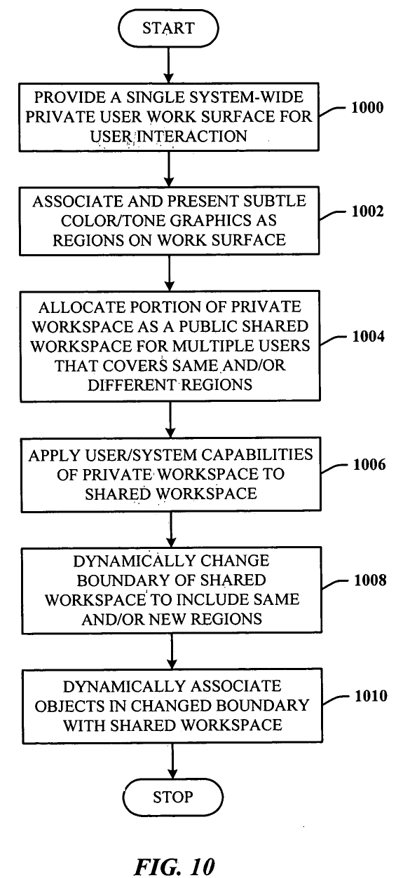

FIG. 10 illustrates a methodology of changing workspace boundaries as part of the user interaction. At 1000, a single system-wide user work surface is provided for user interaction by a local user, and functions as a private workspace. At 1002, work surface regions are defined in the private workspace and represented using subtle graphical colors and tones. At 1004, a portion of the private workspace is allocated (or configured) as a shared workspace for interaction by multiple remote users (one of which can be the local user). The shared workspace can be defined over one or more of the regions defined in the private workspace. At 1006, when the shared workspace is created, user and/or system capabilities provided to the private workspace are automatically applied to the shared workspace. At 1008, the user can dynamically change the boundary or shape of the shared workspace to include additional regions of the private workspace, or reduce the scope of the shared workspace by changing the boundary to no longer include one or more regions. At 1010, data objects now enclosed in the shared workspace are dynamically associated with the shared workspace and its users. Data objects no longer within the shared workspace due to the boundary change are dynamically disassociated with the shared workspace.

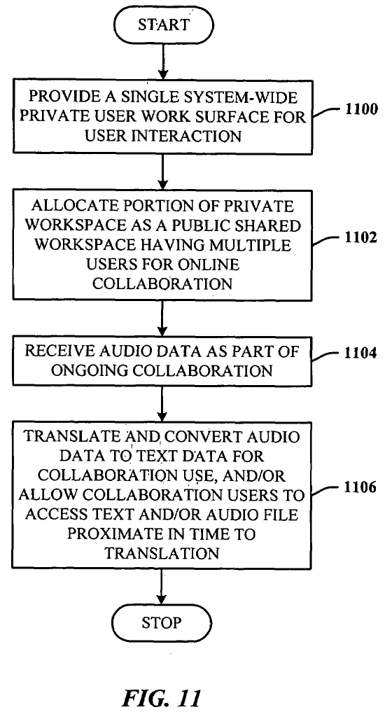

FIG. 11 illustrates a methodology of processing collaboration communications in accordance with a shared workspace. The disclosed innovation provides for an integrated collaboration space within the unified workspace allowing the shared workspace to function, behave and obey the same interaction rules as all other objects (e.g., documents, contacts, data) on the unified workspace. At 1100, a single system-wide single-user work surface is provided for user interaction by a local user, and functions as a private workspace. At 1102, a portion of the private workspace is allocated (or configured) as a shared workspace for interaction by multiple remote users (one of which can be the local user) for collaboration. At 1104, audio data (e.g., voice signals) is received as part of the ongoing collaboration. At 1106, the audio is translated and/or converted into text data for collaboration use, and/or collaboration user access to the text and/or audio file stored and accessible proximate in time to the communication.

In other words, in one implementation, the speech signals from a collaboration participant who participates by voice (e.g., telephone call, VoIP) are automatically received, converted and translated into text for viewing and interaction by one or more other collaboration participants. In another implementation, the voice signals are stored as a voice file, accessed, and then played by a participant. Both of these implementations can be applied for manual selection for collaboration use, or automatic selection according to system and/or user preferences, for example.

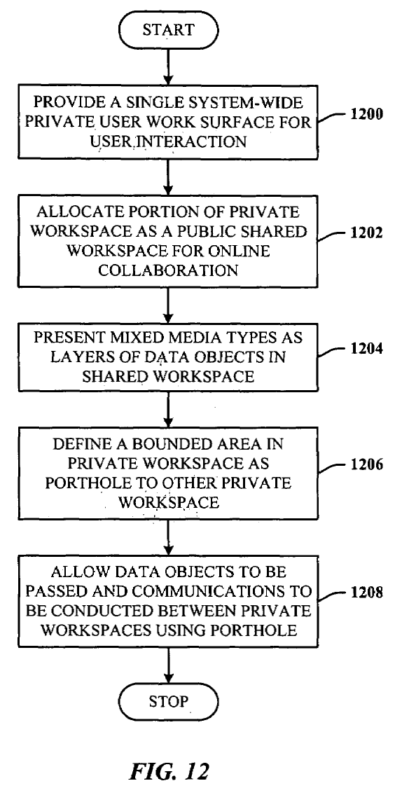

FIG. 12 illustrates a methodology of presenting mixed media types and sharing of data objects. This is the capability to display mixed media in layers on a single display surface. Layering allows data objects to display freely within the shared space without being tied to (embedded with) conversations or other sequential events. At 1200, a single system-wide single-user work surface is provided for user interaction by a local user and functions as a private workspace. At 1202, a portion of the private workspace is configured as a shared workspace for interaction by multiple remote users for collaboration. At 1204, mixed media types can be presented as layers of data objects in the shared workspace. At 1206, a bounded area in the private workspace can be defined as a porthole to another private workspace. At 1208, data objects and physical artifacts can be passed between the private workspaces through the porthole, and communications can be conducted through the porthole between the users of the corresponding private workspaces.

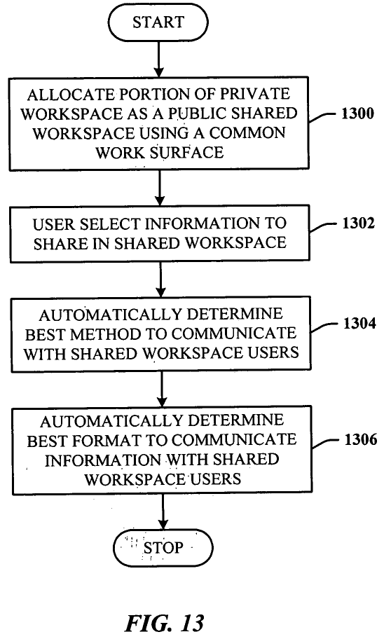

FIG. 13 illustrates a methodology of providing workspace communications according to a best communications method. Various modes of communications (e.g., desktop, mobile) are supported. A collaboration environment can be created to allow the user to choose what information to share, and the system determines the best method (e.g., desktop, phone, mobile) to reach the other participant(s) and the more suitable format (e.g., scales it for desktop, mobile, fax) in which to share the information. At 1300, a portion of a private workspace is allocated as a shared workspace. At 1302, a user selects information to share in the shared workspace. At 1304, the system automatically determines the best method to communicate with the shared workspace users. At 1306, the system then automatically determines the best format to communicate information with shared workspace users.

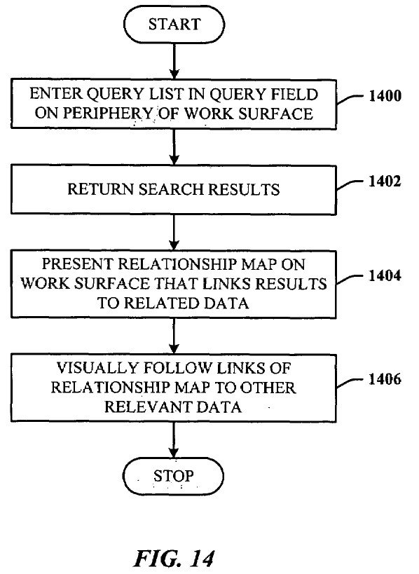

FIG. 14 illustrates a methodology of processing search results by linking results to related data. At 1400, a query list is entered in a query field located on the periphery of the work surface. At 1402, the query is processed and the results returned. At 1404, a relationship map is developed and presented on the work surface that links results to related data. At 1406, the user can visually follow the links of the relationship map to other relevant data.

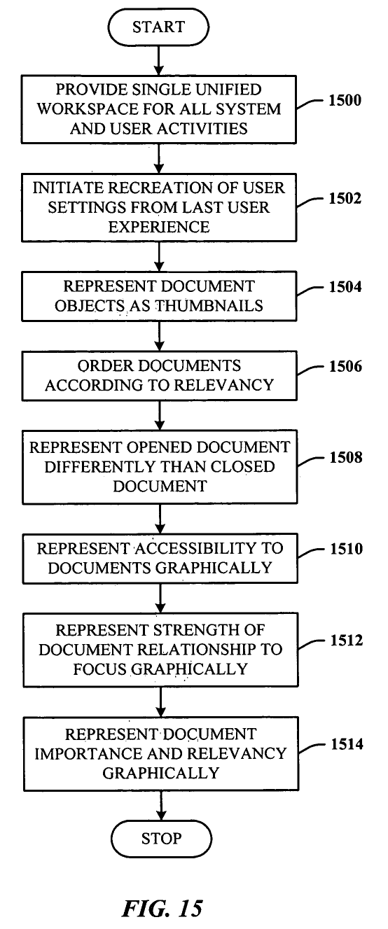

FIG. 15 illustrates a methodology of providing a visually intuitive user experience for a user work environment. At 1500, a single system-wide single-user workspace is provided for all user and system activities. At 1502, the system can re-create the user and workspace settings from the last user experience, since such settings can be automatically saved upon user exit. At 1504, document and/or data objects can be represented as thumbnail images. At 1506, objects (e.g., data, document) can be ordered on the work surface according to relevance. At 1508, an open document can be represented differently than a closed document. At 1510, accessibility to a document can be represented graphically. At 1512, strength of document relationship to focus of the user activity can be represented graphically. At 1514, document importance and relevancy can also be represented graphically for quick and intuitive perception by the workspace user.

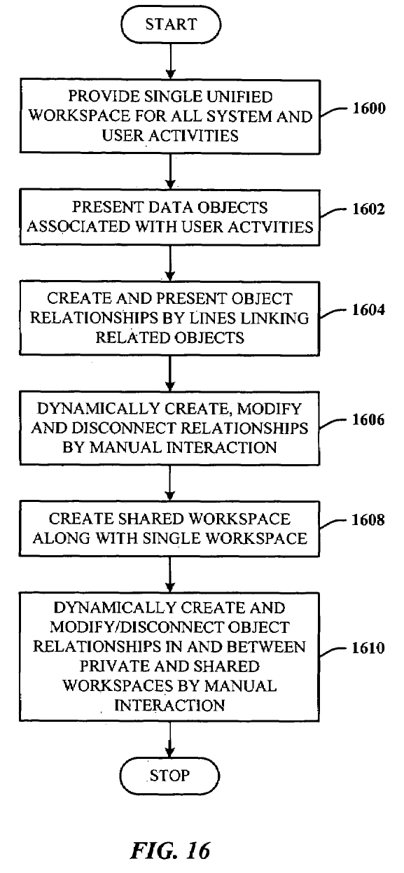

FIG. 16 illustrates a methodology of creating and modifying data object relationships of a workspace. At 1600, a single system-wide single-user workspace is provided for all user and system activities. At 1602, data objects are presented associated with user activities. At 1604, object relationships are created and presented by using lines that link the related objects. At 1606, the object relationships can be dynamically created, modified and disconnected by manual interaction. At 1608, a shared workspace is created as part of the private workspace. At 1610, object relationships between the shared and private workspace can be dynamically created, modified and disconnected by manual interaction.

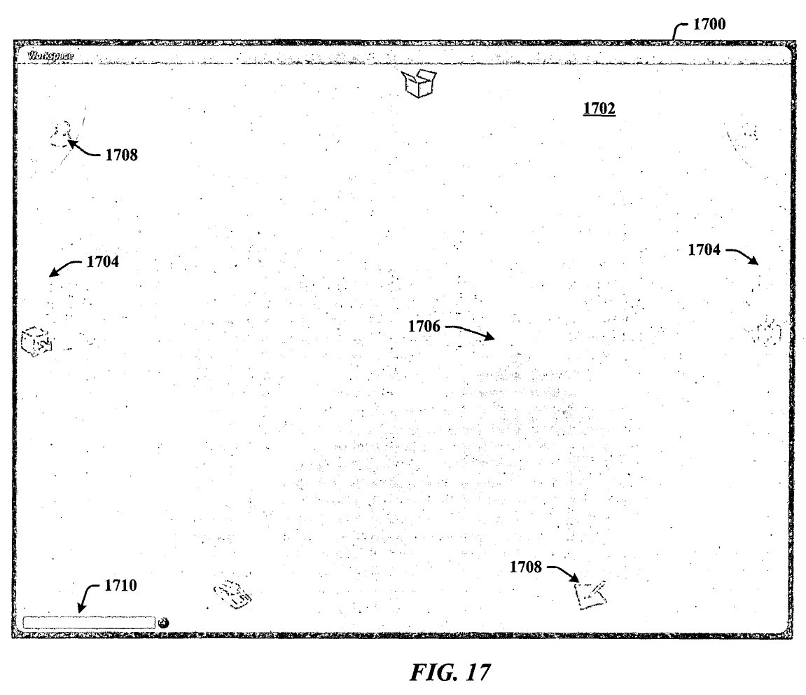

FIGS. 17-38 illustrate screenshots of portions of the unified workspace and some of the associated features. This should by no means be considered an exhaustive exhibition of the features and capabilities of the disclosed user interface. While certain ways of displaying information to users are shown and described with respect to certain figures as screenshots, those skilled in the relevant art will recognize that various other alternatives can be employed. The terms “screen,” “screenshot”, “webpage,” and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

FIG. 17 illustrates the basic unified workspace 1700 having a single work surface 1702 for user and data interaction. Conventionally, it is difficult for a user to remember the placement of items when working on large or high-density display surfaces without visual landmarks. The surface 1702 has defined regions (or landmarks) 1704 around the surface periphery represented by subtle changes in color and tone graphics (e.g., grayed and semi-transparent lines and fill of varying opacity) to make the landmarks 1704 noticeable. This takes advantage of the human processing capability and visual memory and enhances the user's ability in way-finding on a 2D plane. The surface 1702 provides a vanishing point 1706 as a noticeable landmark, and which provides a focus for user activities. Since people tend to remember physical locations more easily then virtual/abstruse locations, placing similar objects in a consistent location (region or landmark) on the workspace surface 1702 can greatly enhance user speed in glancing for quick and specific information. Here, each landmark 1704 has an associated icon or graphic 1708 that represents business logic data and activity for the corresponding region. Other types of representations can be applied according to the discretion of the user. The work surface 1702 also includes a query field and interaction region 1710. Here, the region 1710 is placed along the bottom of the workspace 1700.

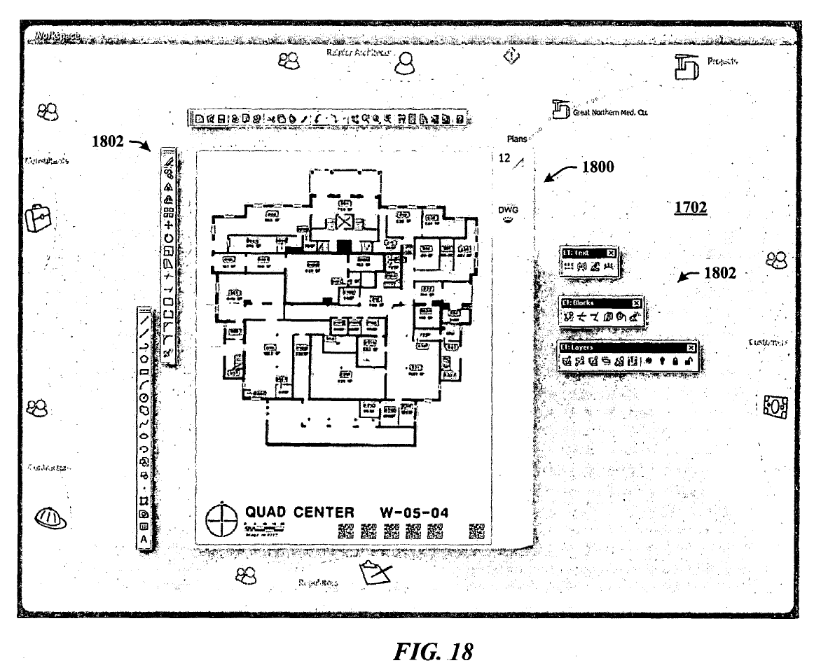

FIG. 18 illustrates a screenshot that represents capabilities of the unified workspace. This includes the capability to aggregate and display data from different sources, the ability to aggregate data from all sources, content type and format (e.g., text audio, video, images) and display them on a single interaction surface. For example, as a data exception occurs, the system can flag the information in question and present the information on the same surface to ease the process of investigation, evaluation and decision for the user. Capabilities further include the implicit elevation of important and exceptional documents or data. The surface shown here illustrates the ability to use business process logic that implicitly elevates important and relevant information to the displace surface to support a user's decisionmaking process. Additionally, the functionality of demand and implicit scaling based on context (e.g., fragment and scaling of functionality) is shown.

In this implementation using business logic, the upper right corner of the surface 1702 includes a Projects region (or landmark) that relates to building construction projects. A floor plan drawing 1800 for a Great Northern Plains project is surfaced. Along with the floor plan drawing 1800 is surfaced application functionality in the form of tool bars 1802, without having to launch the associated functionality applications.

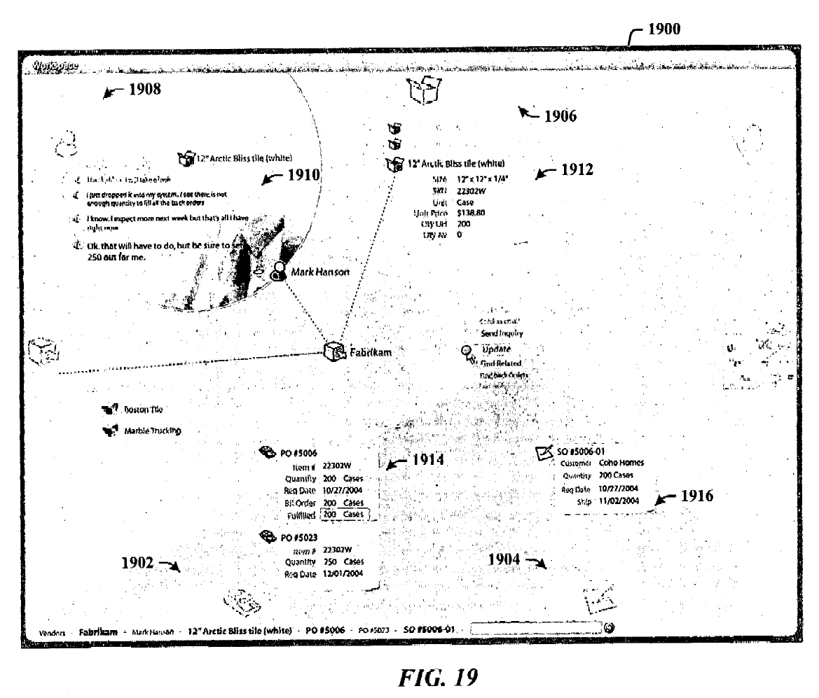

FIG. 19 illustrates a screenshot 1900 that represents the capability of data elevation and layering in accordance with the disclosed architecture. Of particular interest in this screenshot 1900, is the presentation of data and data objects associated with each of a Purchasing region 1902, Shipping region 1904, Products region 1906, and User region 1908. The User region 1906 shows communications 1910 for the user in the form of text. Additionally, text associated with the user communications 1910 is emphasized differently, using colors, opacity variations, and font size variations to represent relevancy, and ranking according to importance or temporal criteria. Size in an object's appearance can be used to indicate importance, for example. This is the concept of using size of an object as cues to show importance. The user can modify the size by explicitly dragging the item in/out for less/more data.

The exposure of a small portion (or subset) of product details data 1912 can be obtained near the Product region 1966. Similarly, a small portion of purchase order (PO) information 1914 related to the product details 1912 is exposed near the Purchasing region 1902. Additional content within an object can be elevated (or exposed) by dragging a corner 1916 of the data block (or graphic) to expand the display box, which reveals more data.

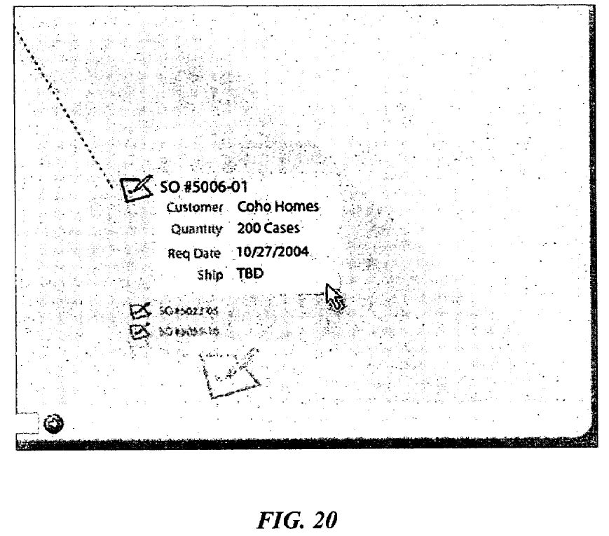

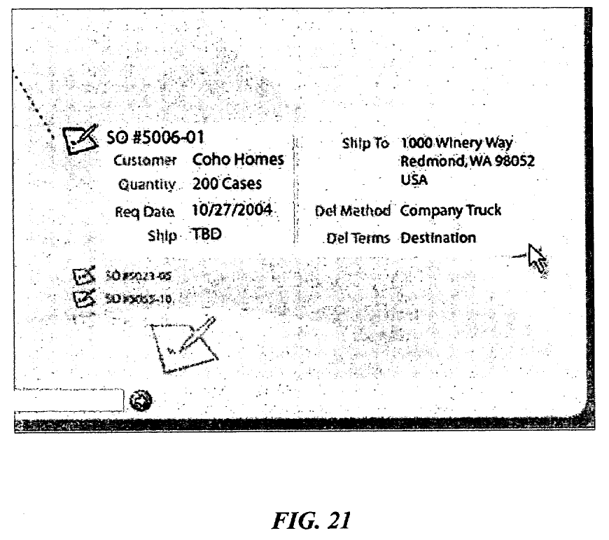

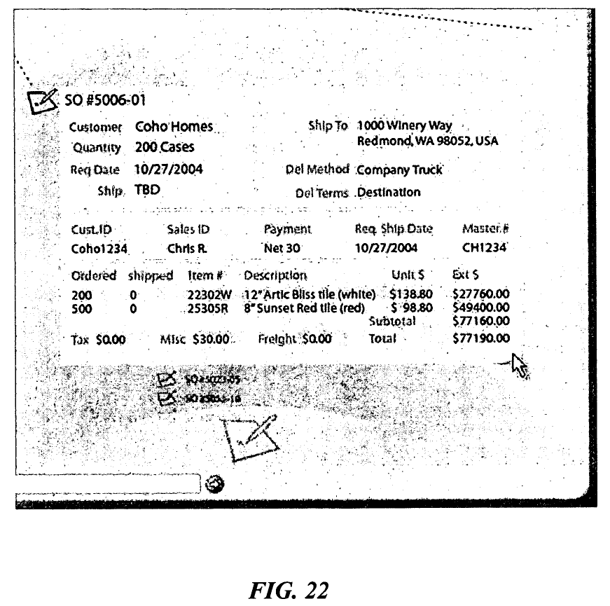

FIG. 20 illustrates a data elevation Level 1 surfacing of data related to a purchase order of FIG. 19. In the example, a Level 1 reveals data in a document marked as most relevant. FIG. 21 illustrates a data elevation Level 2 exposure of more data in a document marked as secondarily relevant. FIG. 22 illustrates a data elevation Level 3 surfacing of the entire data document.

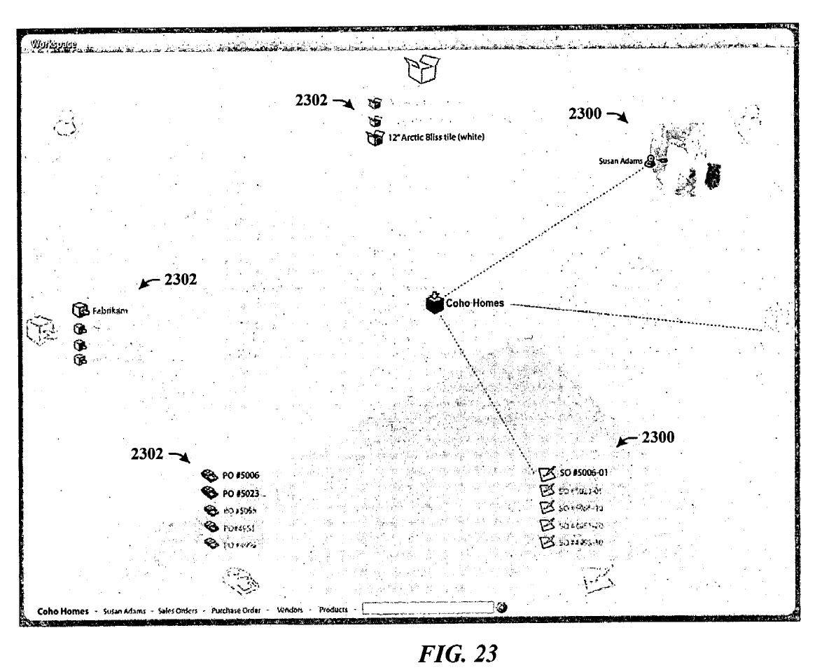

FIG. 23 illustrates data elevation of related objects. Based on the relationship of the primary object(s), related objects also elevate up to the display surface. Objects 2300 are defined as primary objects, and objects 2302 are defined as related objects.

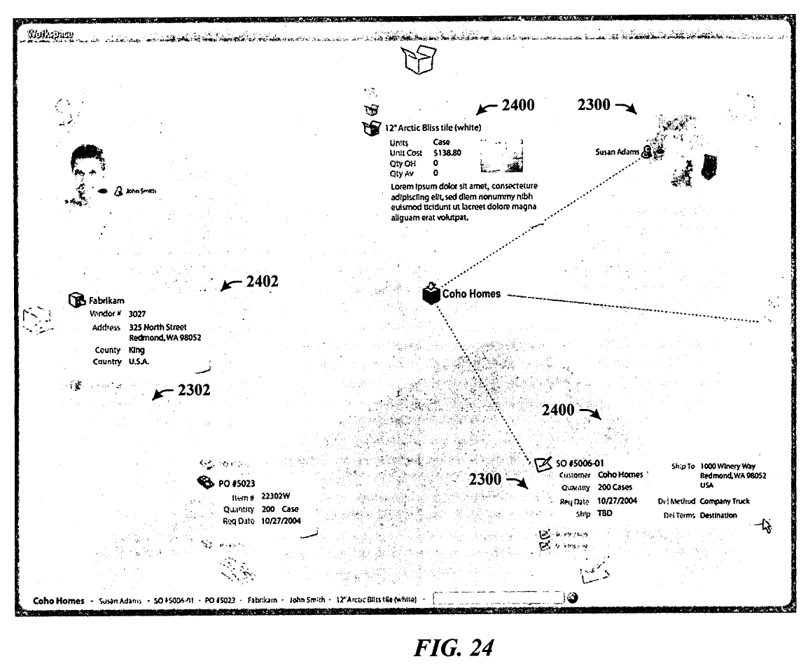

FIG. 24 illustrates that content is elevated based on relationships. Data 2400 on a primary object 2300 is surfaced explicitly and data 2402 on the related object 2302 surfaces itself in an implicit manner.

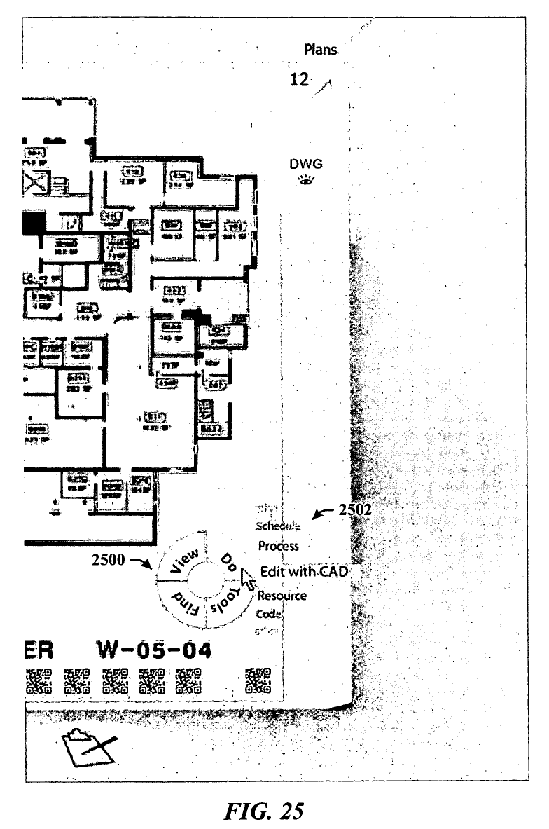

FIG. 25 illustrates a ring menu 2500 that is presented near the point of user activity. The ring menu 2500 is a context-sensitive menu invoked by right clicking on the display surface. A menu 2502 displays around the mouse pointer. Menu content depends on the object, the user clicks, and additional criteria. The menu 2500 can be invoked by right clicking on an object or anywhere on the display surface. The menu 2500 can scale to multiple layers or rings to accommodate the complexity of menu options. When using advanced pointing devices, arraying menu options around a central point leverages a user's pattern recognition capabilities, allowing her/him to take actions more quickly, since distinct patterns of movement correlate to certain actions. The system enables users (particularly expert users) to take action faster than they can read menu options.

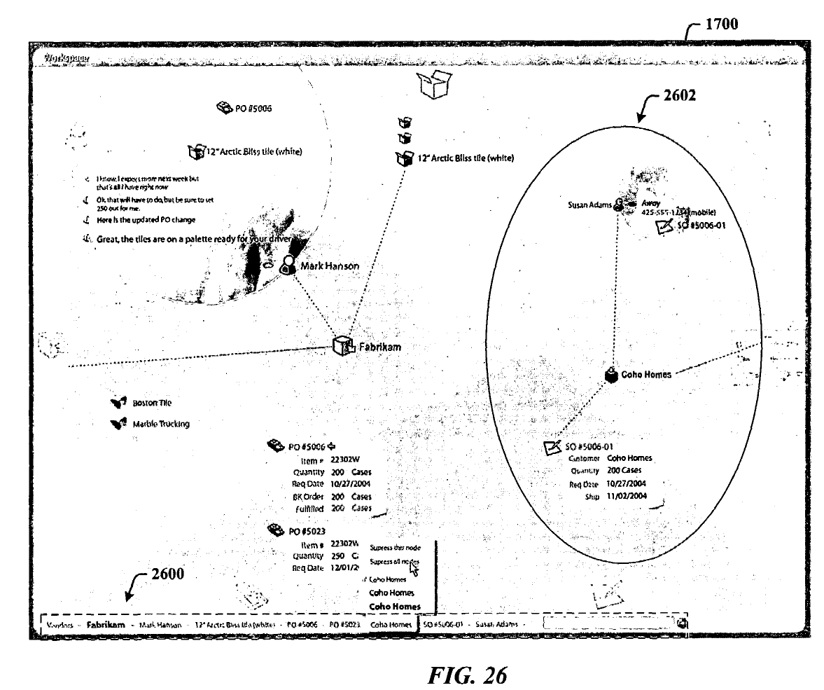

FIG. 26 illustrates a query list 2600 on the workspace 2700. The query list 2600 (circumscribed by a dashed-line box) is more expansive than the query list 1710 of FIG. 17. By right-clicking on the Coho Homes query item, a menu appears and expands where the user can further select a Suppress All Nodes option. In response thereto, all nodes 2602 (circumscribed by an ellipse) related to the Coho Homes object will be suppressed (and not presented for viewing).

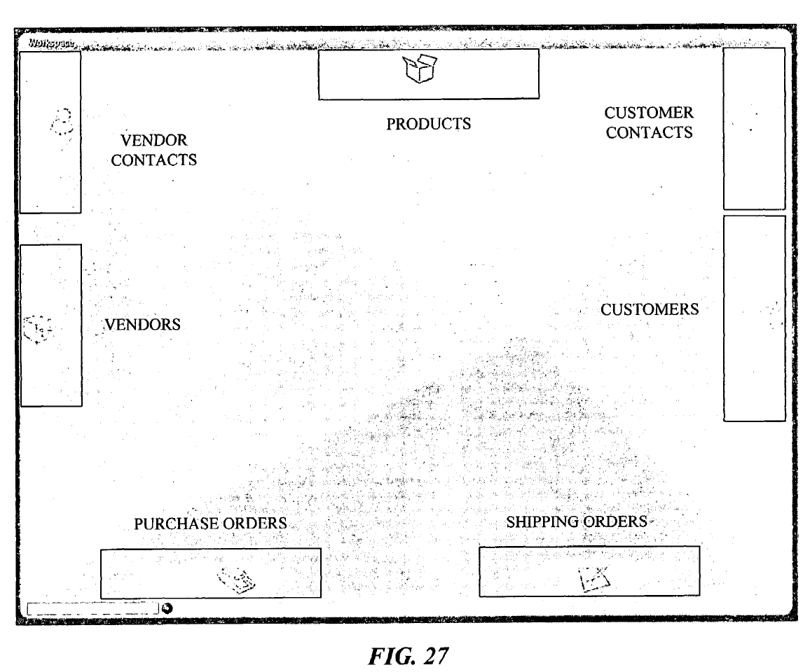

FIG. 27 illustrates the meaningful regions in business logic implementation of the workspace work surface. Meaningful regions (or landmarks) are the design concept of defining/placing similar objects in a consistent location of the unified workspace as a way to aide the user in glancing for specific information. Here, the work surface includes seven regions: a vendor contracts region, a vendors region, a purchase orders region, a shipping orders region, a customers region, a customer contacts region, and a products region. In this implementation, the meaningful regions are positioned around the periphery of the work surface.

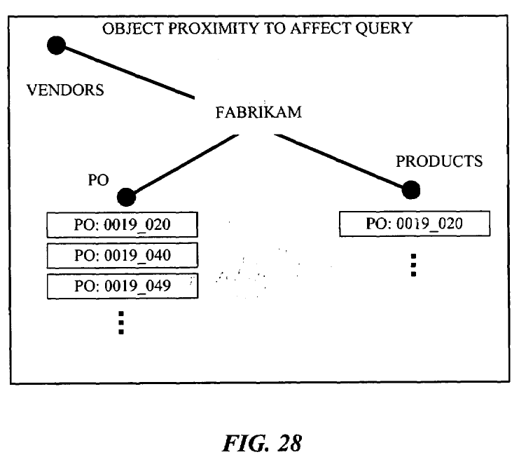

FIG. 28 illustrates that by adjusting object proximity, creation and/or changing of a query will be affected. Data object proximity can be employed to construct new or refine and existing query and search. This is the concept of moving two or more objects closer together (based on the proximity of the objects with each other) to automatically create a new query result set or refine existing search results. For example, as the PO and Products nodes moves closer, the less relevant data fades. Relationship links established between these groups and more detailed data elevates up to the surface as well.

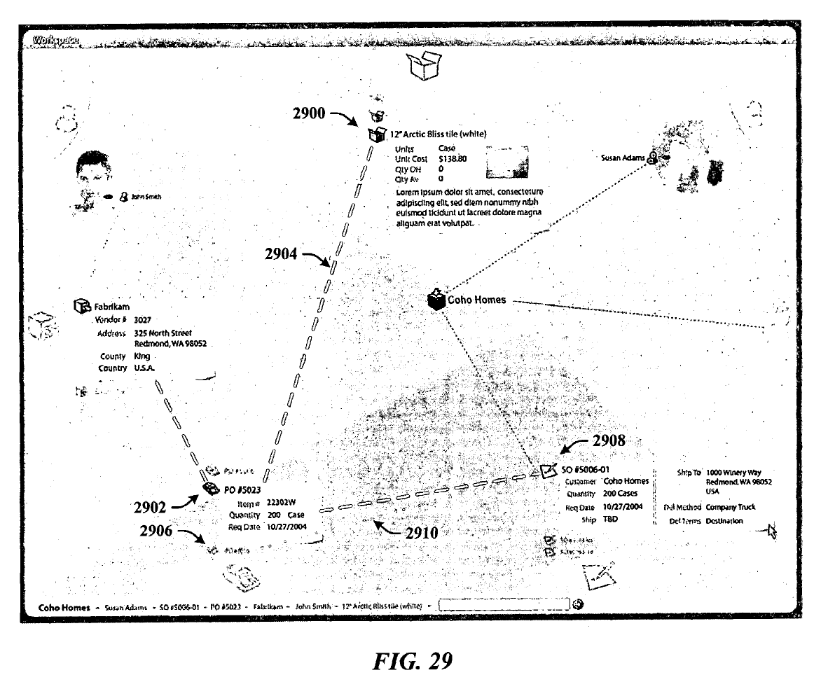

FIG. 29 illustrates the use of line style and weight to indicate the strength and relationship type. This concept uses lines to connect objects with direct relations based on preset business logic or any other criteria. The line weight shows the strength of the relationship and the line style (solid and dashed) represents various types of relations. Here, the relationship between a product 2900 and its associated purchase order 2902 is strong, as indicated by a dashed white line (or link) 2904 with a weight higher than a relationship between a less relevant purchase order 2906 and a shipping order 2908, having a link represented by a dotted line 2910 and more transparency than the line 2904.

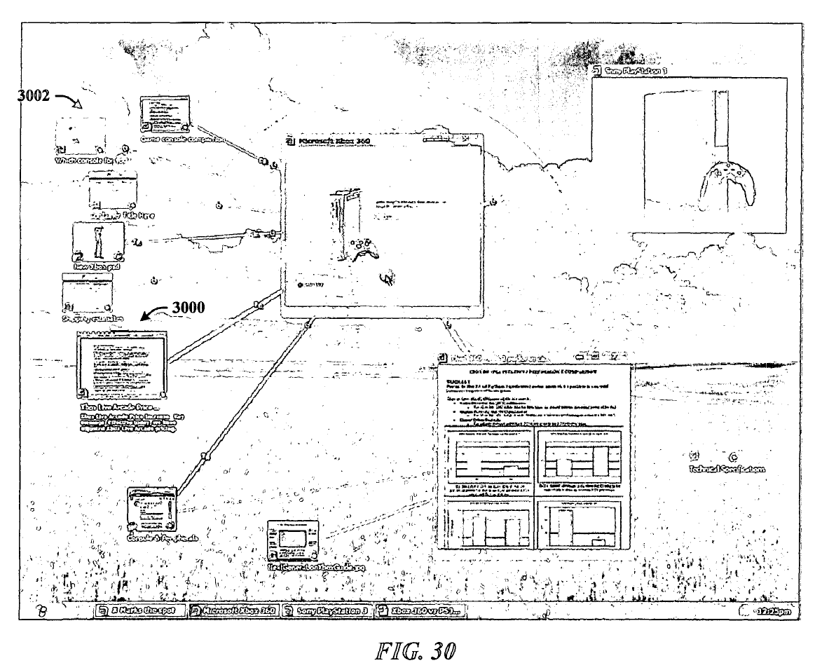

FIG. 30 illustrates the use of color and opacity in object appearance to represent data/data object relevancy. The design concept is to use solid and tinted colors to emphasize and de-emphasize the importance of data elements. By doing so, the system creates a visual hierarchical structure on the screen and help users to visually scan information quickly. Here, more relevant objects 3000 are represented with less opacity than less relevant objects 3002. Note also that the color can be made brighter (or whiter) for more relevant objects.

Preset relationships can be based on existing business logic, for example. The capability is provided to use existing business logic (e.g., workflow, rules) and then create the necessary document/data relationships and data elevation schema. The UI presents the key information (focus object) requested by the user in an easy managed amount (elevated data) as well as other related information (peripheral information) based on preset business logic.

Object relationships can be, derived from usage via an assisted discovery list. This is the capability to display related items and information about these items based on usage data to support the user in recreating their work settings by easing the process of finding related documents regardless of their physical locations in the system. When a supporting software component is running, any open window triggers the display of a list of related documents. If multiple windows are open, related documents are displayed to all windows and highlights those documents related to the focus window as well as differentiating strongly and weekly related to the just now focused window, access availability and, opened and closed items. Double clicking on any item can launch the item in a new window regardless of its physical location. If an item is already opened, the action brings the opened window into focus and highlights the related document to the just now focused window. It presents the user with a collection of documents related to the open window(s) and arranged by their relevancy.

Relationships can be user defined where the user explicitly creates and disconnects by drag and drop, for example. This is the capability to allow users to create, modify and disconnect relationships on the fly without coding. Simple actions are supported by dragging one item onto another to establish new relation or cutting the linking line to break the relationship. These actions can apply to one or more instances as well.

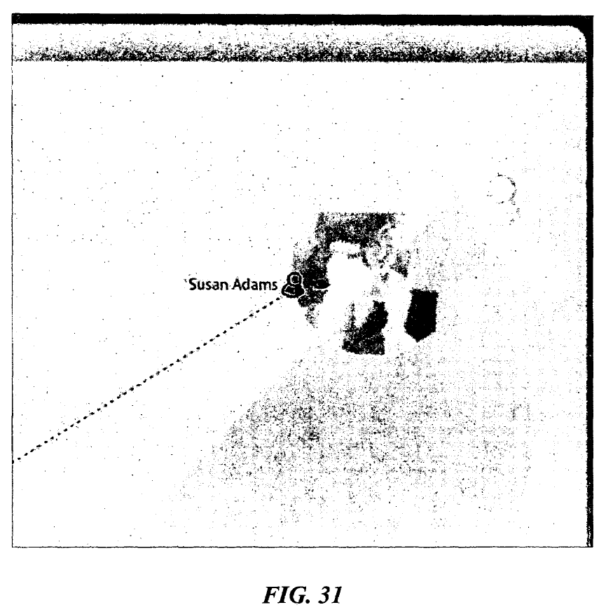

FIG. 31 illustrates the creation of a shared workspace in a private workspace. A shared workspace can be opened with a remote user (e.g., a member of a contact list). If both the local (or current) and remote users are online or available, the communication can be in realtime; if not, communication and shared object(s) stored in the system can be read and retrieved when the user comes online.

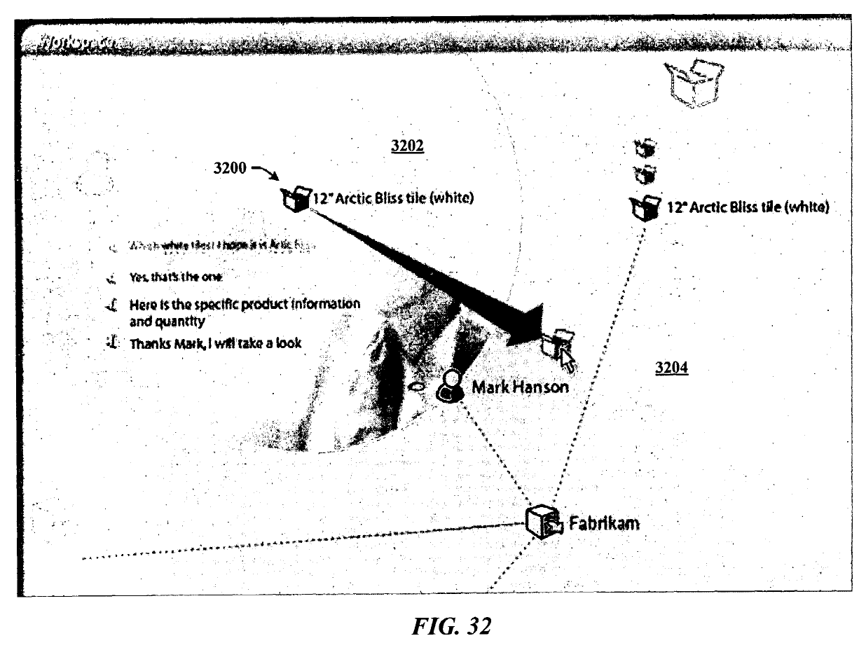

FIG. 32 illustrates that objects can be dragged between private and public workspaces to share the objects. Objects dragged into a shared space are public for all participants in the conversation and objects dragged into the private space become private to the local user. Each object retains the knowledge of its context as well as establishes new ones when it moves into the private space. Here, a product object 3200 is dragged from the public workspace 3202 to the private workspace 3204. Dragging and relating/correlating of data elements allow the user to establish a relationship between two or more objects by dragging an object onto another. For example, object A and B are two unrelated data objects. By dragging object A onto object B, the user can specify to establish a relationship between the objects. When A appears in a query result, B surfaces as related to A with the user-defined relationship, and vice versa.

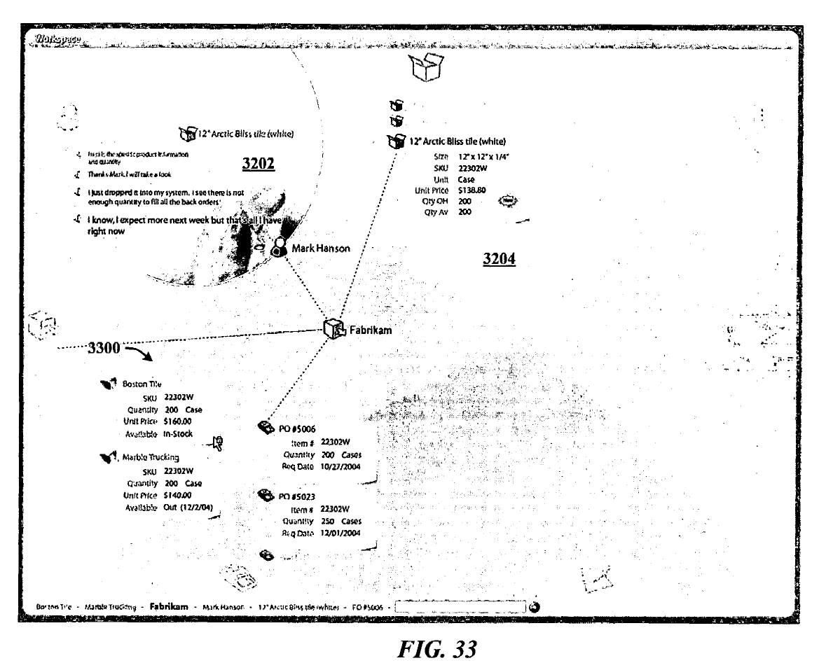

FIG. 33 illustrates that moving objects from the shared workspace 3202 into the private workspace 3204 triggers business rules for the system to launch web services that retrieve more relevant data 3300 (e.g., a partner's inventory for product availability and price).

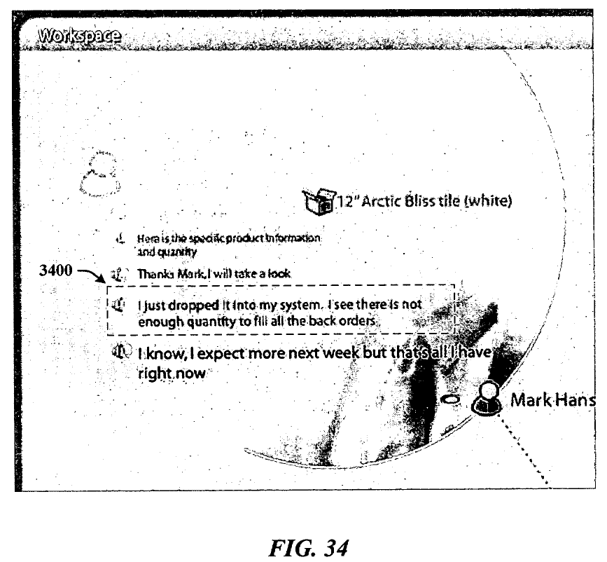

FIG. 34 illustrates that a shared workspace user can participate remotely by voice that can be converted into text 3400 and displayed as an ongoing dialogue on the work surface.

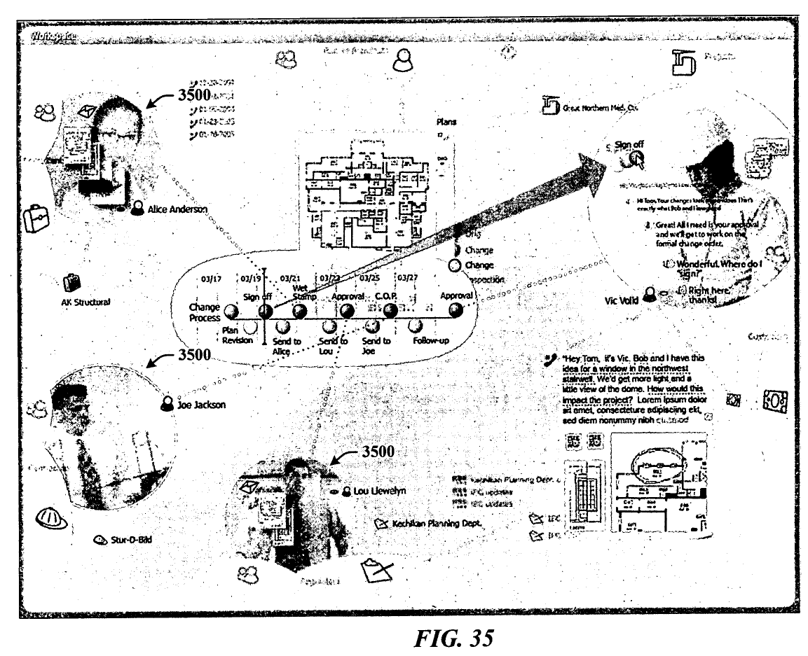

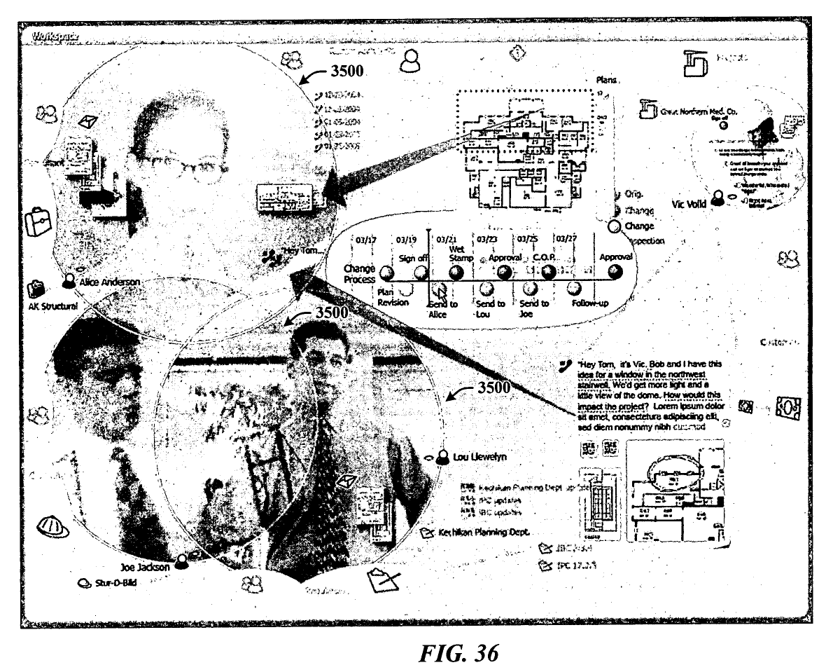

The following FIGS. 35 and 36 illustrate that the unified workspace also facilitates dragging open (or expanding) to share more work surface and objects (e.g., share an entire region or a specific part of the private workspace). For example, by expanding the SWS to cover multiple regions on the UWS, the system allows information surfaced in these areas to be shared automatically without any other explicit actions. The user can define what and how much to share with others. FIG. 35 illustrates an initial layout of workspace coverage before user expansion of user spaces 3500. FIG. 36 illustrates the final layout or expansion of the user spaces 3500.

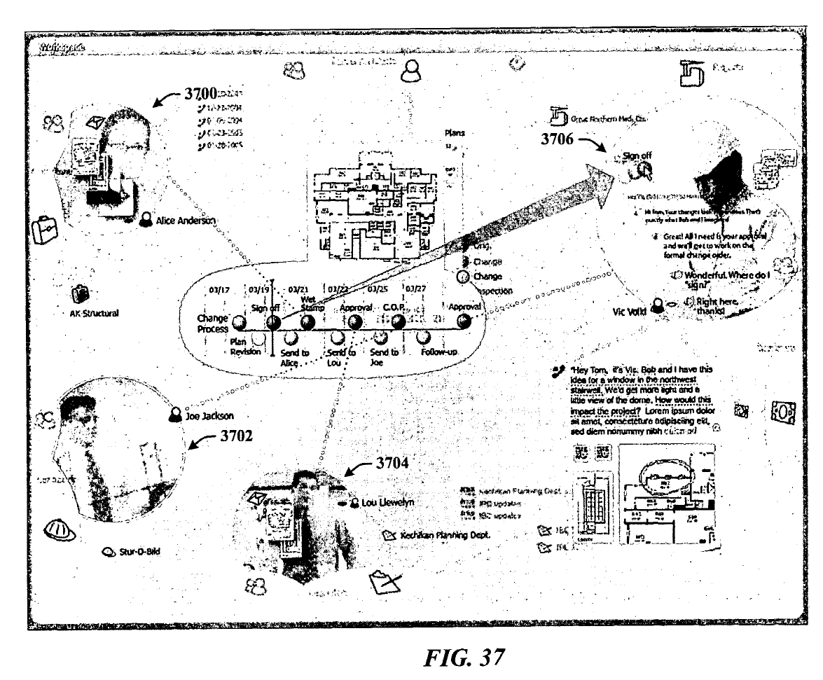

FIG. 37 illustrates the various modes of communications that can be facilitated by the unified workspace environment. A first user 3700 is offline. A second user 3702 is participating via a desktop computer in an office. A third user 3704 participates via a laptop computer while being out of the office. A fourth user communicates via a cell phone or other device capable of mobile communications.

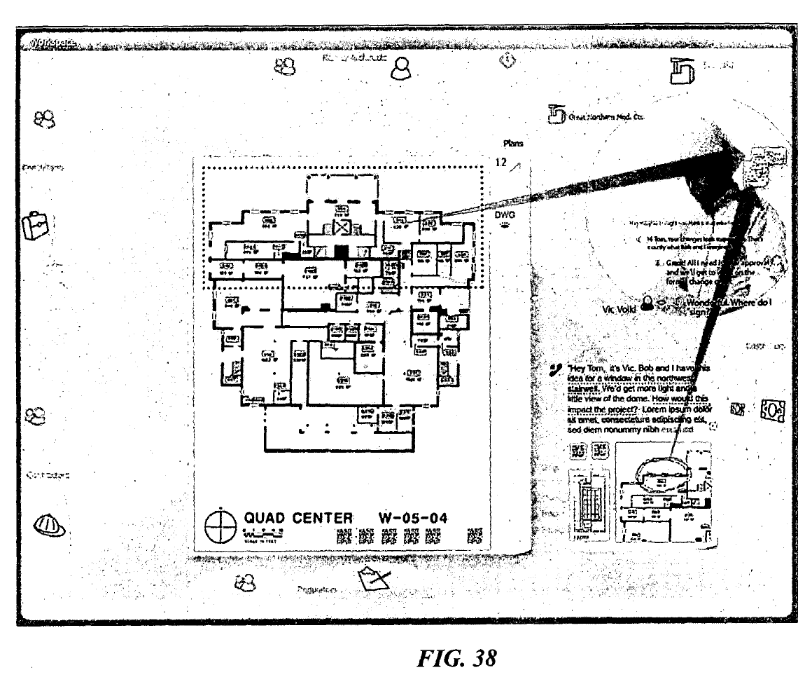

FIG. 38 illustrates the layering of disparate media types via the workspace. Users can interact with video, images, text, business objects, documents and other artifacts placed on a conceptual “plane” between the local user and the remote user.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

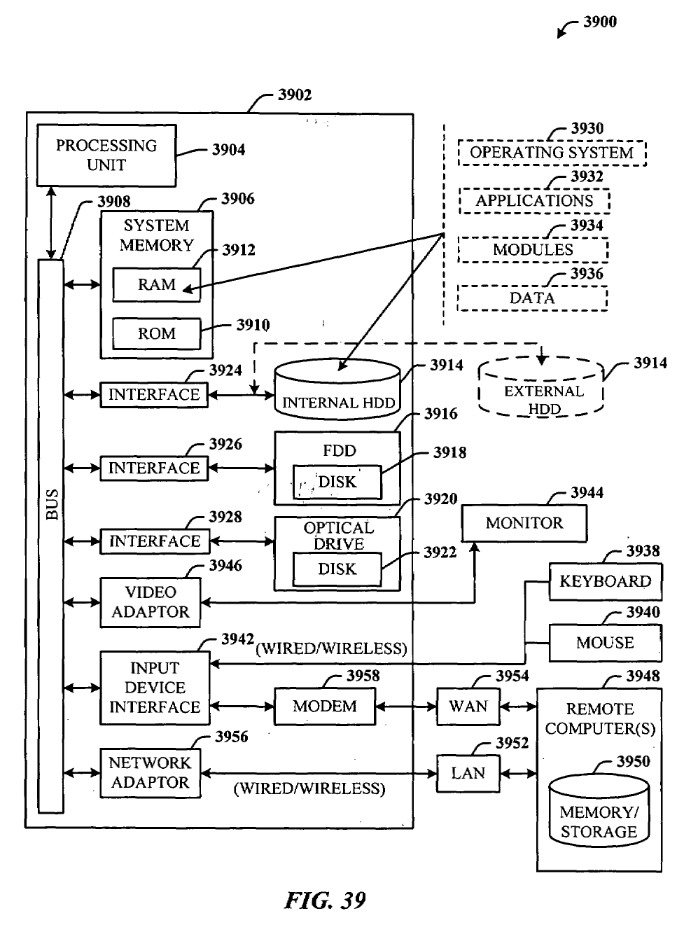

Referring now to FIG. 39, there is illustrated a block diagram of a computer operable to execute the disclosed unified workspace architecture. In order to provide additional context for various aspects thereof, FIG. 39 and the following discussion are intended to provide a brief, general description of a suitable computing environment 3900 in which the various aspects of the innovation can be implemented. While the description above is in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be: used to store the desired information and which can be accessed by the computer.

With reference again to FIG. 39, the exemplary environment 3900 for implementing various aspects includes a computer 3902, the computer 3902 including a processing unit 3904, a system memory 3906 and a system bus 3908. The system bus 3908 couples system components including, but not limited to, the system memory 3906 to the processing unit 3904. The processing unit 3904 can be any of various commercially available processors. Dual microprocessors and other multi-processor architectures may also be employed as the processing unit 3904.

The system bus 3908 can be any of several types of bus structure that may further interconnect to a memory bus (with or without a memory controller), a peripheral bus, and a local bus using any of a variety of commercially available bus architectures. The system memory 3906 includes read-only memory (ROM) 3910 and random access memory (RAM) 3912. A basic input/output system (BIOS) is stored in a non-volatile memory 3910 such as ROM, EPROM, EEPROM, which BIOS contains the basic routines that help to transfer information between elements within the computer 3902, such as during start-up. The RAM 3912 can also include a high-speed RAM such as static RAM for caching data.

The computer 3902 further includes an internal hard disk drive (HDD) 3914 (e.g., EIDE, SATA), which internal hard disk drive 3914 may also be configured for external use in a suitable chassis (not shown), a magnetic floppy disk drive (FDD) 3916, (e.g., to read from or write to a removable diskette 3918) and an optical disk drive 3920, (e.g., reading a CD-ROM disk 3922 or, to read from or write to other high capacity optical media such as the DVD). The hard disk drive 3914, magnetic disk drive 3916 and optical disk drive 3920 can be connected to the system bus 3908 by a hard disk drive interface 3924, a magnetic disk drive interface 3926 and an optical drive interface 3928, respectively. The interface 3924 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 3902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed innovation.

A number of program modules can be stored in the drives and RAM 3912, including an operating system 3930, one or more application programs 3932, other program modules 3934 and program data 3936. All or portions of the operating system, applications, modules, and/or data can also be cached in the RAM 3912. It is to be appreciated that the innovation can be implemented with various commercially available operating systems or combinations of operating systems.

A user can enter commands and information into the computer 3902 through one or more wired/wireless input devices, for example, a keyboard 3938 and a pointing device, such as a mouse 3940. Other input devices (not shown) may include a microphone, an IR remote control, a joystick, a game pad, a stylus pen, touch screen, or the like. These and other input devices are often connected to the processing unit 3904 through an input device interface 3942 that is coupled to the system bus 3908, but can be connected by other interfaces, such as a parallel port, an IEEE 1394 serial port, a game port, a USB port, an IR interface, etc.

A monitor 3944 or other type of display device is also connected to the system bus 3908 via an interface, such as a video adapter 3946. In addition to the monitor 3944, a computer typically includes other peripheral output devices (not shown), such as speakers, printers, etc.

The computer 3902 may operate in a networked environment using logical connections via wired and/or wireless communications to one or more remote computers, such as a remote computer(s) 3948. The remote computer(s) 3948 can be a workstation, a server computer, a router, a personal computer, portable computer, microprocessor-based entertainment appliance, a peer device or other common network node, and typically includes many or all of the elements described relative to the computer 3902, although, for purposes of brevity, only a memory/storage device 3950 is illustrated. The logical connections depicted include wired/wireless connectivity to a local area network (LAN) 3952 and/or larger networks, for example, a wide area network (WAN) 3954. Such LAN and WAN networking environments are commonplace in offices and companies, and facilitate enterprise-wide computer networks, such as intranets, all of which may connect to a global communications network, for example, the Internet.

When used in a LAN networking environment, the computer 3902 is connected to the local network 3952 through a wired and/or wireless communication network interface or adapter 3956. The adaptor 3956 may facilitate wired or wireless communication to the LAN 3952, which may also include a wireless access point disposed thereon for communicating with the wireless adaptor 3956.

When used in a WAN networking environment, the computer 3902 can include a modem 3958, or is connected to a communications server on the WAN 3954, or has other means for establishing communications over the WAN 3954, such as by way of the Internet. The modem 3958, which can be internal or external and a wired or wireless device, is connected to the system bus 3908 via the serial port interface 3942. In a networked environment, program modules depicted relative to the computer 3902, or portions thereof, can be stored in the remote memory/storage device 3950. It will be appreciated that the network connections shown are exemplary and other means of establishing a communications link between the computers can be used.

The computer 3902 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

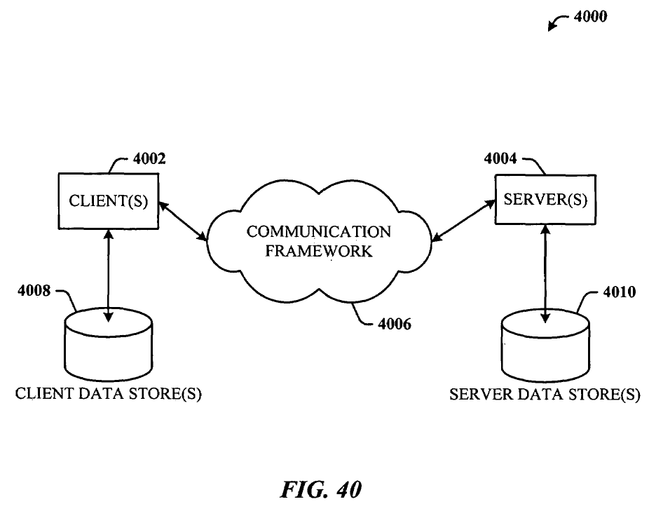

Referring now to FIG. 40, there is illustrated a schematic block diagram of an exemplary computing environment 4000 that facilitates communications and data exchange for users of the unified workspace environment. The system 4000 includes one or more client(s) 4002. The client(s) 4002 can be hardware and/or software (e.g., threads, processes, computing devices). The client(s) 4002 can house cookie(s) and/or associated contextual information by employing the subject innovation, for example.

The system 4000 also includes one or more server(s) 4004. The server(s) 4004 can also be hardware and/or software (e.g., threads, processes, computing devices). The servers 4004 can house threads to perform transformations by employing the architecture, for example. One possible communication between a client 4002 and a server 4004 can be in the form of a data packet adapted to be transmitted between two or more computer processes. The data packet may include a cookie and/or associated contextual information, for example. The system 4000 includes a communication framework 4006 (e.g., a global communication network such as the Internet) that can be employed to facilitate communications between the client(s) 4002 and the server(s) 4004.

Communications can be facilitated via a wired (including optical fiber) and/or wireless technology. The client(s) 4002 are operatively connected to one or more client data store(s) 4008 that can be employed to store information local to the client(s) 4002 (e.g., cookie(s) and/or associated contextual information). Similarly, the server(s) 4004 are operatively connected to one or more server data store(s) 4010 that can be employed to store information local to the servers 4004.

What has been described above includes examples of the disclosed innovation. It is, of course, not possible to describe every conceivable combination of components and/or methodologies, but one of ordinary skill in the art may recognize that many further combinations and permutations are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system that facilitates a user work environment, comprising:
a presentation component for providing a visual presentation of sets of information and a relationship between the sets of information; and
an application component that allows direct user interaction with the sets of information and the relationship, and preserves results of the user interaction.

2. The system of claim 1, further comprising a workspace component that facilitates a shared workspace that allows multiple users to share and exchange data objects, applies business rules to the exchange of the data objects and incorporates the data objects into the workspace.

3. The system of claim 2, wherein the workspace component facilitates the simultaneous presentation of different sets of information from multiple different sources.

4. The system of claim 1, further comprising a customization component for providing a customized set of application functions related to a specific aspect of a user task associated with the sets of information.

5. The system of claim 1, further comprising a data component for automatically surfacing only information relevant to a user task.

6. The system of claim 5, wherein the data component facilitates aggregation of different types of the information as a set of information and surfaces only the relevant different types of the information for presentation.

7. The system of claim 5, wherein the data component facilitates implicit surfacing of the relevant information.

8. The system of claim 5, wherein the relevant information surfaced by the data component is at least one of predefined by a user, defined at design time, and system learned.

9. The system of claim 5, wherein the relevant information surfaced by the data component forms a basis for accessing a remaining portion of the information.

10. The system of claim 1, wherein the application component automatically provides an application function for use in performing a user task associated with the sets of information and elevates the function by performing a partial launch of the associated application, the function based on at least one of a type of business, device, access privileges and a user task.

11. A computer-implemented method of providing a user work environment, comprising:
providing a single system-wide user work surface for user interaction;
visually presenting sets of relevant information and relationships between the sets;
performing a task that includes at least one of editing and reviewing one or more of the sets of information, the task associated with one or more applications; and
exposing an application function of the one or more applications based on context and type of the information, the application function exposed based on a partial launch of the associated application.

12. The method of claim 11, further comprising implicitly elevating relevant information associated with business logic to the work surface for a support decisionmaking process.

13. The method of claim 11, further comprising creating a shared workspace associated with the work surface for access by other users to share and exchange data objects.

14. The method of claim 13, further comprising storing a relationship between data objects as the data objects are moved between a shared workspace and a private workspace.

15. The method of claim 13, further comprising representing object relationship, strength of relationship, and relevancy graphically.

16. The method of claim 11, further comprising automatically generating a query via the work surface based on proximity of a first object to a second object.

17. The method of claim 11, further comprising generating data relationships based on at least one of preset by underlying business logic, usage, and user-defined actions.

18. The method of claim 11 further comprising automatically determining an optimum mode of communication with each participant of collaboration space defined in association with the work surface.

19. The method of claim 11, further comprising switching the work surface to an editing surface for direct manipulation of the information.

20. A computer-executable system that facilitates a user work environment, comprising:
computer-implemented means for visually and graphically presenting a work surface having regions that correspond to different business objects;
computer-implemented means for visually and graphically presenting sets of data objects and set relationships in association with the work surface regions;
computer-implemented means for interacting with data objects associated with one or more of the regions;
computer-implemented means for exposing application functions of applications associated with the respective data objects for manipulation of the data, the functions exposed by partially launching the associated application;
computer-implemented means for automatically elevating data related to the data objects based on the interaction; and
computer-implemented means for implicitly and explicitly generating the relationships between the data objects.
